(19) United States
(12) Patent Application Publication
(10) Pub. No.: US 2026/0197155 A1
(43) Pub. Date: Jul. 9, 2026

(54) DIRICHLET CONVOLUTION-BASED CRYPTOGRAPHY METHODS AND SYSTEMS

(71) Applicant: Noumerica Data Security Inc., Saskatoon (CA)

(72) Inventors: Artur SOWA, Saskatoon (CA); Francis BUI, Saskatoon (CA); Jonathan NORTON, Saskatoon (CA); Grant Harris McEWEN, Saskatoon (CA); Elias HASSANI SANGANI, Saskatoon (CA)

(21) Appl. No.: 19/554,802

(22) Filed: Mar. 3, 2026

Related U.S. Application Data
(63) Continuation of application No. PCT/CA2024/050722, filed on May 30, 2024.

(30) Foreign Application Priority Data
Sep. 5, 2023 (CA) 3211089

(51) Int. Cl. H04L 9/08

(52) U.S. Cl. CPC H04L 9/0819; H04L 9/0869

(57) ABSTRACT

Methods, devices and systems for encryption and decryption of data. Encryption is performed using one or more passes of Dirichlet convolution involving an encryption key, which may be combined with other invertible operations. Decryption is performed using a corresponding number of passes of a Dirichlet inverse operation using a decryption key, and the corresponding invertible operations.

### CROSS-REFERENCE TO RELATED APPLICATIONS

This application is a continuation of PCT International Application No. PCT/CA2024/050722, filed May 30, 2024, which claims priority to Canadian Patent Application No. 3,211,089, filed Sep. 5, 2023, the entire content of each of which is incorporated herein by this reference.

### FIELD

The disclosed embodiments relate to cryptography and, in particular, to symmetric cryptography.

### BACKGROUND

Certain types of data, such as image data, can be impractical to encrypt using conventional methods due to its bulkiness or size (see, e.g., Li et al., “Chaos-based encryption for digital images and videos,” Multimedia security handbook, CRC Press, 2005, chapter 4).

One conventional encryption technique is one-time pad (OTP) encryption. OTP encryption is a method of encrypting data by using a unique, randomly generated key that is used only once. The key is the same length as the plaintext message being encrypted, and each bit or byte of the plaintext is XORed with the corresponding bit or byte of the key to produce the ciphertext. Because the key is never reused, OTP encryption provides perfect secrecy, meaning that even if an adversary has access to the ciphertext and the algorithm used for encryption, they will not be able to determine the original plaintext message. However, because the key is of the same length as the message to be encrypted, OTP encryption is impractical for bulky data.

Another common encryption technique is public key cryptography, also known as asymmetric cryptography, which uses a pair of keys: a public key and a private key. The public key is used to encrypt data, while the private key is used to decrypt it. Anyone can use the public key to send an encrypted message, but only the holder of the corresponding private key can decipher it. This allows for secure communication over an insecure channel, as the sender can be sure that only the intended recipient can read the message. This method relies on complex mathematical problems, such as factoring large numbers (as in Rivest-Shamir-Adleman or “RSA”) or computing discrete logarithms (as in Diffie-Hellman or “DH”), to ensure the security of the encryption process. However, this complexity also makes the encryption computationally inefficient, even more so for bulky data, to the extent that many hardware processors incorporate dedicated processing units to accelerate these operations.

Private key cryptography, also known as symmetric encryption, uses a single secret key for both encrypting and decrypting data. In this method, a single key is used to encrypt and decrypt messages. The key is kept secret by all parties involved in the communication, and only those with access to the key can read the encrypted message. This type of encryption involves bitwise operations and/or block cipher algorithms, as in Advanced Encryption Standard (AES). While faster and more efficient than public key cryptography, private key cryptography still has computational requirements that make it inefficient for encrypting bulky data.

Another encryption technique is chaos-based encryption. Chaos-based encryption uses the unpredictable behavior of chaotic systems to encrypt data. In this method, a chaotic map is used to generate a pseudorandom sequence that is then used to encrypt the plaintext data. The chaotic map is typically a simple mathematical formula that exhibits complex and seemingly random behavior when iterated. By using the output of the chaotic map as a key stream, the encryption process can be made highly secure and resistant to attacks. Chaotic functions are built upon the foundation of a seed and characterized by a mathematical map, such as the logistic map, the Henon map, the Chebyshev map, etc. Chaotic maps have an extremely sensitive response to initial state and control parameters with ergodicity and pseudo-randomness characteristics making the generated sequences suitable for security purposes (see, e.g., Kanso et al., “An efficient and robust image encryption scheme for medical applications,” Communications in Nonlinear Science and Numerical Simulation, vol. 24, no. 1-3, pp. 98-116, 2015; Ali et al., “A novel medical image signcryption scheme using TLTS and Henon chaotic map,” IEEE Access, vol. 8, pp. 71 974-71 992, 2020; Yasser et al., “A robust chaos-based technique for medical image encryption,” IEEE Access, vol. 10, pp. 244-257, 2021). However, the encryption uses floating point calculations rather than integer operations. Accordingly, the performance of such methods may be degraded in a platform with limited precision. Moreover, decryption may result may be imperfect rather than lossless. There have been reports of good quality reconstruction (see, e.g., Hua et al., “Cosine-transform-based chaotic system for image encryption”, Information Sciences 480, pp. 403-419, 2019), but completely lossless reconstruction has not been claimed using these techniques. Finally, the use of floating point calculations makes chaos-based encryption less efficient than integer-based approaches.

A combination of chaotic maps and quantum processes has been proposed, e.g., by Lin et al., “Intelligent symmetric cryptography with chaotic map and quantum based key generator for medical images infosecurity,” IEEE Access, vol. 9, pp. 118 624-118 639, 2021. This encryption method involves a substitution cypher changing pixel values in a 2D image via a 256 key-space cipher. However, the method is computationally intense, and the encrypted image retains some characteristics of the input. The latter method is purely local, encrypting each pixel separately in a manner akin to historical cyphers. However, most methods proposed in contemporary literature rely on a multi-step engineered process, based on image segmentation, permutation, and diffusion. This achieves the goal of making the pixel values of the encrypted image depend on a cluster of other pixels.

Still other encryption techniques have been proposed, particularly for encryption of images, such as in U.S. Pat. Nos. 10,819,881, 9,883,215, 9,853,809, 8,948,385, 11,362,282, 6,892,940, and in U.S. Patent Publication No. 2022/0121758.

### SUMMARY

The following summary is intended to introduce the reader to various aspects of the detailed description, but not to define or delimit any invention.

In at least one broad aspect, there is provided a method of encrypting a file, the method including: obtaining an encryption key, the encryption key comprising an integer array; segmenting the file into a plurality of arrays of a unit size; encrypting the plurality of arrays to generate a plurality of encrypted arrays by performing Dirichlet convolution of the encryption key over each of the plurality of arrays; and combining the plurality of encrypted arrays into an encrypted file; and storing or transmitting the encrypted file.

In some cases, the Dirichlet convolution includes multiple passes, and the encrypting may include, after at least one pass of the Dirichlet convolution that produces a plurality of intermediate arrays, performing at least one additional pass of the Dirichlet convolution on the plurality of intermediate arrays.

In some cases, the encrypting comprises, before or after at least one pass of the Dirichlet convolution that produces a plurality of intermediate arrays, performing at least one invertible operation on the plurality of intermediate arrays.

In some cases, the at least one invertible operation includes a cyclic shift.

In some cases, the at least one invertible operation includes an order reversal.

In some cases, the at least one invertible operation includes framing.

In some cases, the encryption key is obtained by: determining at least one dimension of the file; determining an encryption strength; generating the encryption key using a random number generator, and the encryption key may include a string of random integers, and the number and range of random integers in each encryption key is determined based on the at least one dimension of the file and the encryption strength.

In some cases, the file is an image file and the at least one dimension of the file comprises a length dimension and a width dimension.

In some cases, the Dirichlet convolution is performed using operations in a finite field.

In some cases, the Dirichlet convolution is performed using integer arithmetic with a bit size B.

In some cases, the integer arithmetic is performed modulo-P, where P is a prime number larger than the bit size B.

In some cases, P the prime number is a smallest prime number larger than the bit size B.

In some cases, the method may include providing the encryption key to a recipient of the encrypted file, and the encryption key is provided out-of-band to the encrypted file.

In some cases, the method may include computing a decryption key, and providing the decryption key to a recipient of the encrypted file, and the decryption key is provided out-of-band to the encrypted file.

In some cases, the decryption key is the Dirichlet inverse of the encryption key.

In some cases, the file is formatted in a lossless image file format.

In some cases, the file is a color image, and the color image is parsed into a plurality of channels, and the encrypting may include encrypting each of the channels.

In another broad aspect, there is provided a method of decrypting an encrypted file, the method including: obtaining a decryption key, the decryption key comprising an integer array; dividing the encrypted file into a plurality of encrypted arrays of a unit size; decrypting the plurality of encrypted arrays to generate a plurality of arrays by performing Dirichlet convolution of the decryption key over each of the plurality of encrypted arrays; and combining the plurality of arrays into a file; and storing or transmitting the file.

In some cases, the decryption key includes an indication of a number of Dirichlet convolution passes to be performed during the decrypting.

In some cases, the decryption key includes an indication of at least one invertible operation to be performed during the decrypting.

In another broad aspect, there is provided a device for encrypting a file, the device including: one or more processors configured to: obtain an encryption key, the encryption key comprising an integer array; divide the file into a plurality of arrays of a unit size; encrypt the plurality of arrays to generate a plurality of encrypted arrays by performing Dirichlet convolution of the encryption key over each of the plurality of arrays; and combine the plurality of encrypted arrays into an encrypted file; and store or transmitting the encrypted file.

In some cases, the Dirichlet convolution includes multiple passes, and the encrypting may include, after at least one pass of the Dirichlet convolution that produces a plurality of intermediate arrays, performing at least one additional pass of the Dirichlet convolution on the plurality of intermediate arrays.

In some cases, the encrypting includes, after at least one pass of the Dirichlet convolution that produces a plurality of intermediate arrays, performing at least one invertible operation on the plurality of intermediate arrays.

In some cases, the at least one invertible operation includes a cyclic shift.

In some cases, the at least one invertible operation includes an order reversal.

In some cases, the at least one invertible operation includes framing.

In some cases, the encryption key is obtained by: determining at least one dimension of the file; determining an encryption strength; generating the encryption key using a random number generator, and the encryption key includes a string of random integers, and the number and range of random integers in each encryption key is determined based on the at least one dimension of the file and the encryption strength.

In some cases, the file is an image file and the at least one dimension of the file comprises a length dimension and a width dimension.

In some cases, when a byte size of the file is not an integer multiple of the unit size, the dividing comprises padding at least one array of the plurality of arrays.

In some cases, the Dirichlet convolution is performed using operations in a finite field.

In some cases, the Dirichlet convolution is performed using integer arithmetic with a bit size B.

In some cases, the integer arithmetic is performed modulo-P, where P is a prime number larger than the bit size B.

In some cases, P the prime number is a smallest prime number larger than the bit size B.

In some cases, the one or more processors are further configured to provide the encryption key to a recipient of the encrypted file, and the encryption key is provided out-of-band to the encrypted file.

In some cases, the one or more processors are further configured to compute a decryption key, and provide the decryption key to a recipient of the encrypted file, and the decryption key is provided out-of-band to the encrypted file.

In some cases, the decryption key is the Dirichlet inverse of the encryption key.

In some cases, the file is formatted in a lossless image file format.

In some cases, the decryption key includes an indication of a number of Dirichlet convolution passes to be performed during the decrypting.

The device of claim 35, wherein the decryption key includes an indication of at least one invertible operation to be performed during the decrypting.

In some cases, the file is a color image, and the color image is parsed into a plurality of channels, and the encrypting may include encrypting each of the channels.

In some cases, the file includes a plurality of frames, and the encrypting includes encrypting each of the frames.

In another broad aspect, there is provided a device for decrypting an encrypted file including: one or more processors configured to: obtain a decryption key, the decryption key comprising an integer array; divide the encrypted file into a plurality of encrypted arrays of a unit size; decrypt the plurality of encrypted arrays to generate a plurality of arrays by performing Dirichlet convolution of the decryption key over each of the plurality of encrypted arrays; and combine the plurality of arrays into a file; and store or transmit the file.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a flowchart diagram of an example encryption method in accordance with at least some embodiments;

FIG. 2 is a flowchart diagram of an example decryption method in accordance with at least some embodiments;

FIGS. 3A to 3D illustrate unencrypted and encrypted image data, along with histograms of the same;

FIG. 4 illustrates an unencrypted image with padding; and

FIG. 5 is a schematic block diagram of a computer in accordance with at least some embodiments.

### DETAILED DESCRIPTION

The described embodiments provide for the encryption of large quantities of data, such as image data and the like, in a manner that is computationally efficient. The described approach involves an extremely large key space to mitigate the risk of brute force attacks. In particular, the number of possible encryption keys is typically of an order greater than the number of particles in the universe.

By way of brief explanation, let x, k, and c be elements of a finite abelian group G with operation+ and the neutral element 0. Given ciphertext c=x+k, retrieving the plaintext x=c−k from the ciphertext c is trivial when the key k is known. However, when the key k is unknown, the task is a blind search. Efficient recovery of x can be aided if there is available a criterion for distinguishing x by its characteristic features from all other group elements. Furthermore, even if such a criterion is available, the average number of trials may be prohibitively difficult when the group G is sufficiently large. The described embodiments provide implementations of this schema based on the Dirichlet convolution in a finite field. In this case, the large group G is the group of Dirichlet-invertible sequences of elements of the field. The expression finite field is a technical term that refers to an algebraic structure with operations of addition and multiplication and the usual properties (e.g., every nonzero element has an inverse.

The provided methods, devices and systems for encrypting and decrypting data files facilitate the protection and security of sensitive information during storage, transmission, and exchange. Existing encryption techniques described in the literature typically involve multi-step processes. While these methods enhance security, they may be computationally intense or may be lossy. The described embodiments overcome shortcomings of existing encryption methods by combining encryption software components, mathematical algorithms, and advanced key generation processes. This enables the secure encryption and decryption of data files, including bulky data such as digital images, videos, multidimensional vector data, and more.

One aspect of the described embodiments is the generation of encryption and decryption keys, which may be selected based on a dimension of the data to be encrypted. For example, when encrypting image data, the dimensions of the input image may be determined. Optionally, an encryption strength can be obtained from computer memory or a human interface device. Subsequently, a random number generator function is applied to create one or more encryption keys. These keys are strings of random integers, with the number and range of integers determined by the input image dimensions and the selected encryption strength.

Once encryption keys are generated, the input data can be encrypted. The described embodiments generally encrypt data based on Dirichlet convolution of sequences of elements of a finite field. This process, utilizing the encryption keys, results in the creation of encrypted data, which can be stored in computer-accessible memory or transmitted to another device.

To facilitate lossless decryption, a decryptor-generation function is used to obtain one or more decryption keys. The decryptor-generation function, is based on an invertible nonlocal transform in a finite field, and uses the encryption keys as source variables to generate one or more decryption keys.

The one or more decryption keys are transmitted to the recipient out-of-band to the encrypted data. For example, the decryption keys may be transmitted using public key cryptography.

The described embodiments provide a lossless and computationally efficient method for encrypting and decrypting large quantities of data, including image files and multidimensional vector data. Accordingly, the described cryptographic techniques may find application in a wide variety of areas, such as digital image or video exchange, data exchange (e.g., geological testing data), and more. Some embodiments also provide for the obfuscation of encrypted data in lossless image formats.

The described embodiments can also operate on components of data. For example, when applied to color images or to videos (i.e., sequences of images), the described techniques can be used to encrypt color channels independently of each other, or image frames independently of each other, or both.

Existing multi-step encryption methods adhere to the principles laid out by the forefather of information theory, Claude Shannon (see, e.g., Paar and Pelzl, “Understanding cryptography: a textbook for students and practitioners,” Springer Science & Business Media, 2009). In Shannon's view, a strong encryption algorithm should display two fundamental properties: diffusion and confusion. Some types of data, such as images, display high local correlation and redundancy. As applied to images, the essence of diffusion is that a single pixel value in the original image ought to affect the values of many ciphertext pixels. The goal is to mask the statistical properties of the original image. On the other hand, the goal of confusion is to hide correlations between the ciphertext and the key. There is no universal recipe as to the means for attaining confusion. As a result, many encryption methods are engineered via a multi-step process designed to achieve a degree of diffusion, perhaps via some steps, and a degree of confusion, perhaps via other steps.

The described embodiments differ from such multi-step approaches in that the main encryption routine may be carried out in a single step. This step is characterized by nonlocality so that, in the context of image data for example, the value of any given pixel in the encrypted image is a resultant of the values of many pixels in the original. However, this result does not resemble conventional diffusion processes. Likewise, the described embodiments do not require separate steps to achieve a confusion effect. Instead, a single operation has the effect of disassociating any characteristic of the encrypted image with the encryption key.

The following description uses the example of encryption and decryption of digital image data. However, the described approach can be applied to other data types.

The described approach has several basic components or layers:
1. Creation of the secret encryption and decryption keys (and distributing the keys to users).
2. Insertion of additional variables
3. Encryption, i.e., based on Dirichlet convolution
4. Decryption

The described encryption and decryption operations are efficient both in terms of computer memory overhead and in terms of the number of arithmetical operations required.

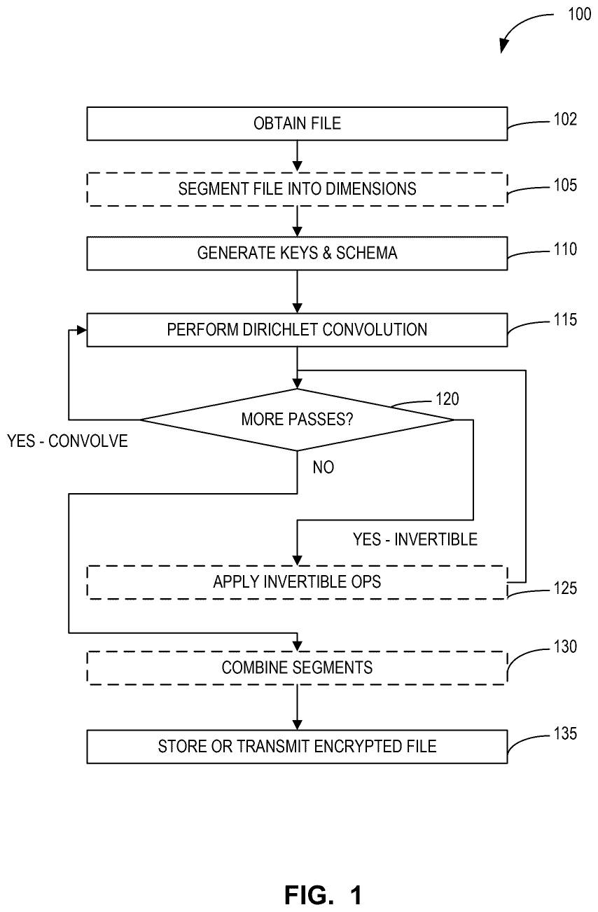

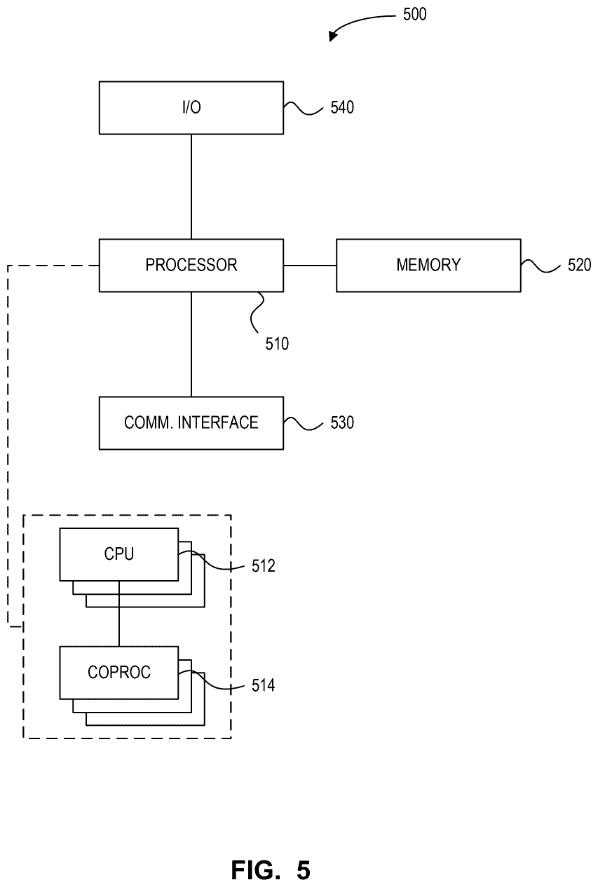

Referring now to FIG. 1, there is illustrated a flow chart diagram of an example method of encryption, in accordance with at least some embodiments. Method 100 may be carried out by a computer, such as the computer 500 described with reference to FIG. 5.

Method 100 begins at 102 by obtaining a file that is to be encrypted. The file may be obtained by, e.g., retrieving from memory or by reception via a communication interface.

At 105, the file to be encrypted is segmented into two or more dimensions. If the file has data that is inherently segmented into dimensions, such as image data that has, e.g., width and height dimensions, then the segmentation may be omitted or considered to be performed using these inherent dimensions.

In general, segmentation into two or more dimensions is performed to organize lower-dimensional data into higher dimensions. For example, single dimensional data of length Q may be organized into rows of length M and columns of length N, where M>N.

In essence, the input file can be divided into a plurality of arrays of a unit size. In the case of a M×N two-dimensional image where M>N, it may be considered that there are N arrays of unit size M (i.e., N 1×M arrays).

At 110, an encryption key is generated along with the encryption schema.

The encryption schema is the order and set of convolutions and invertible operations that is used to generate the encrypted file, and which can be performed in the reverse order to recover the unencrypted file. Invertible operations may include, e.g., cyclic shifts, flips or order reversals, permutations, etc.

A wide variety of encryption schemas can be developed using different combinations and/or permutations of convolutions and invertible operations. All these are reversible operations, and the task of decryption can be accomplished with knowledge of the key and the encryption schema. The encryption schema can be described efficiently as a short sequence of instructions.

Generally, the encryption key is an array of integers, although it will be appreciated that an array of integers may be represented as a single alphanumeric string. The integers generally have a bit size B. In one example embodiment, the bit size is 8, such that each integer is one byte. These 8-bit integers may be represented in decimal terms by the numbers 0 to 255 or, for arithmetic purposes, the numbers 1 to 256.

The length of the encryption key (i.e., the number of integers in the array) is based on the unit size and, optionally, an encryption strength. The encryption strength may be predetermined, for example by a user or in a configuration setting. The encryption strength can be determined by changing the size of the key space. For example, the size of the key space can be diminished by reducing the range of integers forming the encryption key (e.g., instead of K[i] being in the range 1 . . . 256, K[i] may be selected to be in the range 1:7 or so).

As noted, the unit size of the file to be encrypted may be determined based on the largest (i.e., longest) dimension of the data to be encrypted or, if the data is segmented into higher dimensions, the largest of the segmented dimensions. For example, in the case of an image file, the larger of the height and width of the image is chosen as the unit size.

The encryption key is then generated using a random number generator using the unit size and, optionally, encryption strength. In particular, the length of the encryption key, i.e., the number of integers, generally is equal to or greater than a unit size based on the at least one dimension. Accordingly, where there are multiple dimensions inherent in the input data, the length of the encryption key is equal to or greater than the longest of those dimensions. The encryption key may be used to generate subkeys, each also an array of integers, for shorter dimensions through truncation. In this approach, for data with dimensions M×N, where M>N, the encryption key should be at least M in length. The subkey for the M dimension is the entire encryption key, whereas the subkey for the smaller N dimension is a version of the entire encryption key truncated at length N.

In one example, the file to be encrypted may be an image file. In this example, the encryption key consists of an array of random integers, each of value between 1 and 256. The range is selected to begin at 1, rather than 0, to reflect that the arithmetical operations will be integer operations conducted modulo-257. The modulus 257 is chosen as this is the smallest prime number greater than the bit size B. Conversely, the bit size B is selected to correspond with the range of luminance values in each channel of the input image file (i.e., 8-bit). If the range of luminance values is higher, e.g., 10-bit, then the bit size may be set at 10 bits or 16 bits, and the modulus may be selected as 1031 or 65539, respectively.

As noted, the length of the encryption key is chosen based on the unit size, which in the case of an image may correspond to either the width or height dimensions of the image. For simplicity of this example, the image is square, with equal width and height, accordingly the encryption key is equal in length to both the width and height of the image (i.e., M=N). When working with rectangular images, two subkeys are formed, of sizes 1×M (K₁) and 1×N (K₂). If M>N, then subkey K₂ is a truncation of subkey K₁ at length N.

In the case of a square image, there is a single key K with values K[1], K[2], . . . , K[N]. The values of K[i] are independent from one another and each is a random integer in the range from 1 to 256. The encryption key K may be used to encrypt the image file.

To compute a decryption key, the Dirichlet inverse of K, K_{d}, is computed. The Dirichlet inverse of an arithmetic function ƒ is another arithmetic function ƒ⁻¹ such that the Dirichlet convolution (described further below) of ƒ and ƒ⁻¹ is the identity function δ, such that δ[1]=1 and δ[n]=0, when n=2, 3, . . . , N. In the described approach, the Dirichlet inverse computation is performed modulo-P, where P is a prime number greater than B. Generally, P is the smallest prime number equal to or greater than B. The decryption key K_{d} with values K_{d}[1], K_{d}[2], . . . , K_{d}[N], is used for decryption.

The decryption key may be provided to the recipient using a safe medium, such as public key cryptography or quantum key distribution. In some embodiments, an indication of the encryption schema may be incorporated into the decryption key

At 115, Dirichlet convolution is performed over the image data using the encryption key.

In the context of a digital image, each channel of the image generally is represented by a luminance function, which is an M×N matrix. Each position in the matrix can be addressed by the pair (i,j) where i, j=1, 2, . . . , N. Positions may also be referred to as pixels. The luminance function assigns to each pixel a value, denoted X(i,j), which in the case of an 8-bit channel is one of the integers 0, 1, 2, . . . , 255. This range may differ for certain applications such as, e.g., high dynamic range images that have 10-bit channels. In some embodiments, these luminance values may be increased by an offset, such as 1, to occupy the range 1, 2, . . . , 256. That is, each pixel value X(i,j) is replaced by X(i,j)+A, where A is the offset. In cases where an offset is used, the corresponding decryption step will subtract the offset. Alternatively, the offset may be subtracted from the encrypted image. The offset is not always necessary and, in some implementations, it may be omitted.

As used herein, encrypted pixel values are denoted C(i,j).

The Dirichlet convolution is an operation defined on arithmetic functions, which are functions from the positive integers to the complex numbers. The Dirichlet convolution of two arithmetic functions ƒ and g is another arithmetic function, denoted by h=ƒ *g, that is defined as follows:

$$h ( n ) = {\sum }_{d \vert n} f ( d ) ℊ ( \frac{n}{d} )$$

That is, given two sequences ƒ(1), ƒ(2), ƒ(3), . . . and g(1), g(2), g(3), . . . their Dirichlet convolution, denoted h=ƒ *g is a sequence defined as the sum taken over all divisors d of n, so that:

$$h ( 1 ) = f ( 1 ) ℊ ( 1 ) ,$$

$$h ( 2 ) = f ( 1 ) ℊ ( 2 ) + f ( 2 ) ℊ ( 1 ) ,$$

$$h ( 3 ) = f ( 1 ) ℊ ( 3 ) + f ( 3 ) ℊ ( 1 ) ,$$

$$h ( 4 ) = f ( 1 ) ℊ ( 4 ) + f ( 2 ) ℊ ( 2 ) + f ( 4 ) ℊ ( 1 ) ,$$

$$h ( 5 ) = f ( 1 ) ℊ ( 5 ) + f ( 5 ) ℊ ( 1 ) ,$$

$$h ( 6 ) = f ( 1 ) ℊ ( 6 ) + f ( 2 ) ℊ ( 3 ) + f ( 3 ) ℊ ( 2 ) + f ( 6 ) ℊ ( 1 ) ,$$

$$h ( 7 ) = f ( 1 ) ℊ ( 7 ) + f ( 7 ) ℊ ( 1 ) ,$$

$$h ( 8 ) = f ( 1 ) ℊ ( 8 ) + f ( 2 ) ℊ ( 4 ) + f ( 4 ) ℊ ( 2 ) + f ( 8 ) ℊ ( 1 ) , etc .$$

For the purposes of the image encryption example, all sequences are of finite length N.

In at least some of the described embodiments, Dirichlet convolution (and the corresponding Dirichlet inverse) are performed modulo-P, where P is a prime number as described above. That is, multiplication and addition operations are conducted modulo-P. Accordingly, elements ƒ(i), g(i) and h(i) are always integer values between 0 and P−1.

It is known that if a sequence ƒ is such that ƒ(1) is not zero, then the sequence has a Dirichlet inverse, i.e., there is a unique sequence ƒ⁻¹, such that h=ƒ *ƒ⁻¹ satisfies h(1)=1, and h(i)=0 for all i other than 1 (i.e., the function h is the same as the function & described above).

Dirichlet convolution may be implemented via a lifting approach (see Sowa, “Factorizing matrices by Dirichlet multiplication”, Linear Algebra and its Applications, Vol. 438, No. 5, pp. 2385-2393, 2013 This approach requires only 0 (N log N) arithmetical operations and has low memory overhead. In particular, if ƒ and g are recorded in memory, the convolution h can be obtained by first initiating h as a zero-filled array and then modifying it in N iterations. This approach may be carried out as follows:

| | |
|---|---|
| 1. | Input arrays f and g; |
| 2. | Initiate h as a sequence of zeros; and |
| 3. | Execute the following for loop: |
| | for j = 1:N |
| | h(j:j:N) = h(j:j:N) + g(j)*f(1:floor(N/j)); |
| | end |

In this pseudocode, j:j:N refers to the set of indices j, 2j, 3j, . . . that do not surpass N. Also, floor (N/j) refers to the integer part of the ratio N/j.

Once the for loop is completed, h is the Dirichlet convolution of ƒ and g.

The above algorithms generally are performed using modulo-P (e.g., modulo-257, for 8-bit integers) operations.

Dirichlet convolution is the primary component involved in transforming a plaintext input file into an encrypted file. However, the encryption may be made stronger by repletion of the Dirichlet convolution. Similar, the encryption may be made stronger still by, optionally, performing other efficient and invertible operations, such as cyclic shifts of columns or rows, reversal of columns or rows, or framing (described further below). Each time the Dirichlet convolution is applied the computation involves O(N² log N) operations. That is, there is a logarithmic overhead above the data size which is N².

At 120, the computer determines if additional passes of Dirichlet convolution, or any other invertible operations are to be performed, based on the encryption schema identified at 110. If an additional pass of Dirichlet convolution is next in the schema, the computer returns to 115. If an invertible operation is next in the schema, the computer proceeds to 125.

These operations scale linearly with the number of times the Dirichlet convolution is applied, including the supporting invertible operations.

Both the unencrypted data and the encrypted data may be conceptualized as individual points in the space that is the Cartesian product of N² copies of the prime field F_{P} (e.g., F₂₅₇). An adversary wishing to decrypt data to find the original plaintext data X(i,j) knowing only the encrypted ciphertext C(i,j) is looking for N²+N unknowns having only N² equations. Put another way, in principle the constraint (i.e., the cyphertext) allows the adversary to only detect an N-dimensional subspace (variety), rather than the actual plaintext data, which is a single point in the space of all possible data. The equations are polynomial in the encryption key variables and the degree of these multivariate polynomials equals one plus the number of times the Dirichlet convolution has been executed (e.g., the polynomials are of degree 3 if two times, of degree 4 if three times, etc. The plaintext variables X(i,j) enter the equations in first degree.

As an example, assuming that the value of 0 is avoided in both plaintext X(i,j) and in the encryption key, each of these may assume one of 256 values. Thus, for a monochrome image of size 256×256, the image is a point in a discrete space that consists of 256^{256×256}=2⁵²⁴²⁸⁸ points. The constraint determines a subspace that consists of 2²⁰⁴⁸ points. That is, there are 2²⁰⁴⁸ possible keys. This means that even if the adversary knows the encryption schema used, a brute force attack by trial and error for the 256×256 monochrome image may require as many as 2²⁰⁴⁸ trials. There is no known shortcut involving quantum computation or any other method.

The task of decryption can be made more difficult for the adversary by the insertion of additional variables. One such additional variable, which is particularly amenable to image data, is framing. Framing involves inserting random noise into the plaintext. This technique is particularly suited to image data, where the random noise can be used to “frame” the plaintext image data. For example, for a square image, the image dimensions are increased from N×N to (N+2d)×(N+2d). In this case, the original image X(i,j) pixels occupy the middle of the image, and the additional 4d (N+d) pixels form a frame comprised of random noise. As the width and height dimensions are increased, the key size is also increased by 2d. This forces the adversary to search a space (variety) of dimension N+2d. FIG. 4 provides an example of an image of size 256×256 inserted in a frame of width d=20 where the entries are random integers.

Framing is also an invertible operation. In the case of image data, after decryption, the frame can be simply discarded. Also, the time of execution for the insertion of a frame scales in proportion to its size, i.e., it requires 4d(N+d) instances of selecting a random integer in the said range.

Framing also makes it difficult for an adversary to determine whether a cyphertext image has been obtained from any special type of input, like an image consisting of completely or partially dark (zero, or one in the adopted convention) pixels or completely or partially white pixels (value 255, or 256 in the adopted convention).

Most importantly, a frame makes the encryption operation nonlinear, i.e., the encryption of the scaled sum of two images will not be a scaled sum of two encryptions as each input receives a different frame.

Framing will also prevent an adversary from determining the decryption key even if the encryption schema, the plaintext data (X(i,j)) and the encrypted data (C(i,j)) are all known.

Moreover, since framing involves the insertion of new random data each time it is used, it diminishes the problems of key reuse, enabling the same encryption and decryption key to be reused multiple times.

Once the computer has determined at 120 that there are no further passes to be performed, the computer proceeds to 130, to combine the data segments into a single file.

Finally, at 135, the encrypted file is stored and/or transmitted to another device.

While FIG. 1 shows example blocks of method 100, in some implementations, method 100 may include additional blocks, fewer blocks, different blocks, or differently arranged blocks than those depicted in FIG. 1. In particular, although method 100 is shown with an initial pass of Dirichlet convolution, some encryption schemas may call for another invertible operation to be performed prior to the first instance of Dirichlet convolution.

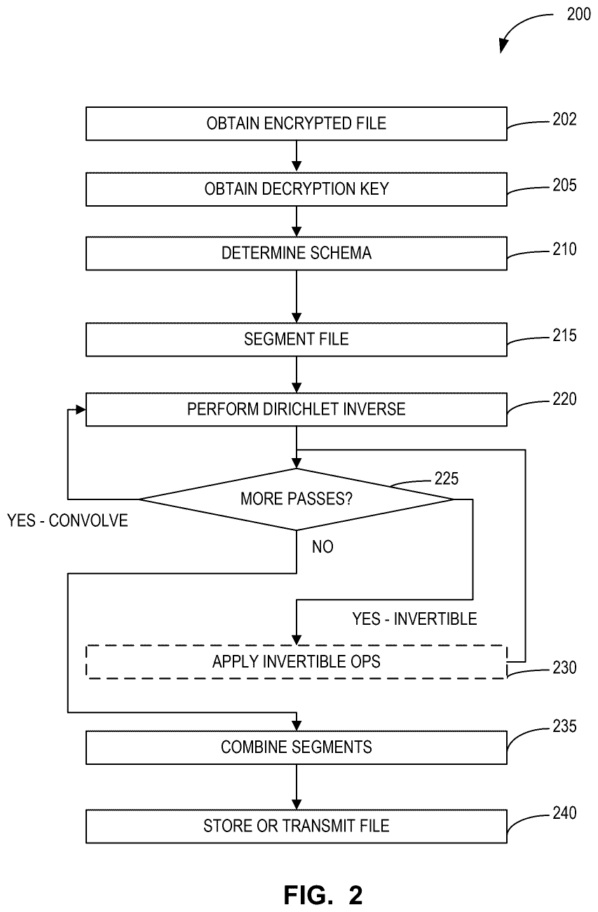

Referring now to FIG. 2, there is illustrated a flow chart diagram of an example method of decryption, in accordance with at least some embodiments. Method 100 may be carried out by a computer, such as the computer 500 described with reference to FIG. 5.

Method 200 begins at 202 by obtaining an encrypted file that is to be decrypted. The encrypted file may be obtained by, e.g., retrieving from memory or by reception via a communication interface.

At 205, the decryption key is obtained by, e.g., reception via a communication interface or retrieving from memory (the key having been received earlier). For example, the decryption key may be received out-of-band using, e.g., public key cryptography.

At 210, the encryption schema is determined. In some embodiments, an indication of the encryption schema may be incorporated into the decryption key. In some other embodiments, the encryption schema may be known a priori, or may be communicated independently of the decryption key.

At 215, the file to be decrypted is segmented into two or more dimensions based on the encryption schema. If the encrypted file has data that is inherently segmented into dimensions, e.g., because it has been formatted into image data that has, e.g., width and height dimensions, then the segmentation may be omitted or considered to be performed using these inherent dimensions.

At 220, the Dirichlet inverse operation is performed over the image data using the decryption key.

The Dirichlet inverse may be computed via an approach similar to the Dirichlet convolution of method 100:

| | |
|---|---|
| 1. | Input array f; |
| 2. | Initiate g(1) = 1/f (1), and set g(j) = 0 for all values of j other than |
| | 1; and |
| 3. | Execute the following for loop: |
| | for k = 1:floor(N/2) |
| | ind = k:k:N; |
| | ind(1) = [ ]; #drop first index in the series |
| | g(ind) = g(ind) + g(k)*f(2:floor(N/k)); |
| | end |

Once the for loop is completed, g is the Dirichlet inverse of ƒ.

As with Dirichlet convolution, computation of the Dirichlet inverse requires only O(N log N) arithmetical operations.

Likewise, the above algorithms generally are performed using modulo-P (e.g., modulo-257, for 8-bit integers) operations.

At 225, the computer determines if additional passes of the Dirichlet inverse operation, or any other invertible operations are to be performed, based on the encryption schema identified at 210. If an additional pass of the Dirichlet inverse operation is next in the schema, the computer returns to 220. If an invertible operation is next in the schema, the computer proceeds to 230.

Once there are no further passes to be performed, the computer proceeds to 235, to combine the data segments into a single file.

Finally, at 240, the encrypted file is stored and/or transmitted to another device.

While FIG. 2 shows example blocks of method 200, in some implementations, method 200 may include additional blocks, fewer blocks, different blocks, or differently arranged blocks than those depicted in FIG. 2. In particular, although method 200 is shown with an initial pass of the Dirichlet inverse operation, some encryption schemas may call for another invertible operation to be performed prior to the first instance of the Dirichlet inverse operation.

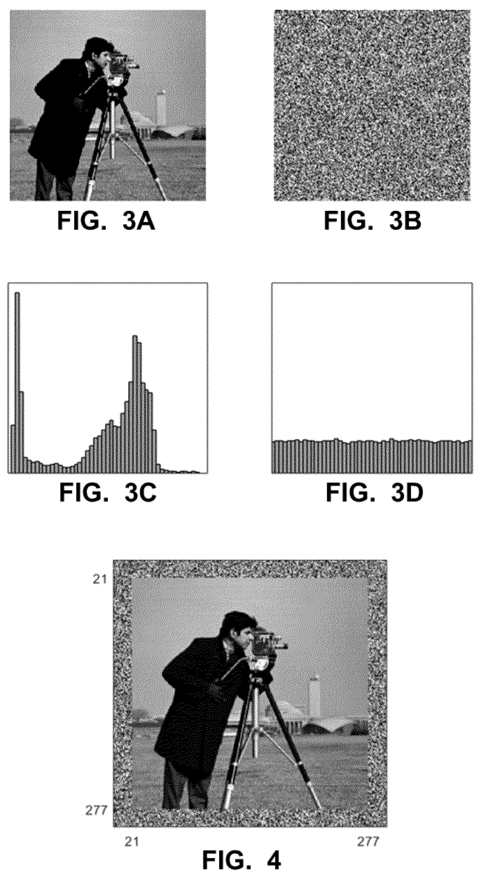

Referring now to FIGS. 3A to 3D, there are provided examples of encrypted and unencrypted image data, along with their accompanying histograms. FIG. 3A is an unencrypted monochrome digital image of size 256×256. FIG. 3B is an encrypted image of the same size generated using one of the described embodiments. FIG. 3C is a histogram of the original image, while FIG. 3D is a histogram of the encrypted image, which is flat and indicates that the encrypted image approximates random noise and offers resistance to frequency analysis attacks. With the decryption key, the plaintext image data can be recovered easily. Without the key, it would be infeasible, as a 2040-bit key would require about 10⁶¹⁴ trials.

Although examples have been provided using image data, the approach described herein can be used for the encryption of any other type of data. This is particularly so if it is convenient to convert that data into the format where it can be interpreted and manipulated as matrices with integer values.

Conversely, the described approach can be transferred to other data formats. For example, rather than converting a text file into matrix form to carry out the described approach, the arithmetical operations involved in the described approach can be adapted to operate on the original file format in which the data is stored.

Referring now to FIG. 5, there is illustrated a simplified block diagram of a computer in accordance with at least some embodiments. Computer 500 has at least one processor 510 operatively coupled to at least one memory 520, at least one communications interface 530 (also herein called a network interface), and at least one input/output device 540.

The at least one memory 520 includes a volatile memory that stores instructions executed or executable by processor 510, and input and output data used or generated during execution of the instructions. Memory 520 may also include non-volatile memory used to store input and/or output data along with program code containing executable instructions.

Processor 510 may transmit or receive data via communications interface 530, and may also transmit or receive data via any additional input/output device 540 as appropriate.

In some cases, the processor 510 includes a system of central processing units (CPUs) 512. In some other cases, the processor includes a system of one or more CPUs 512 in combination with one or more coprocessing units, such as Graphical Processing Units (GPUs) or Tensor Processing Units (TPUs) 514 that are coupled together.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. Further, and in addition to the CPUs described herein, the distributed computing components may also include one or more processing units capable of high performance floating point or vector processing, such as graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

What is claimed is:

1. A method of encrypting a file, the method comprising:
obtaining an encryption key, the encryption key comprising an integer array;
segmenting the file into a plurality of arrays of a unit size;
encrypting the plurality of arrays to generate a plurality of encrypted arrays by performing Dirichlet convolution of the encryption key over each of the plurality of arrays; and
combining the plurality of encrypted arrays into an encrypted file; and
storing or transmitting the encrypted file.

2. The method of claim 1, wherein the Dirichlet convolution comprises multiple passes, and wherein the encrypting comprises, after at least one pass of the Dirichlet convolution that produces a plurality of intermediate arrays, performing at least one additional pass of the Dirichlet convolution on the plurality of intermediate arrays.

3. The method of claim 1, wherein the encrypting comprises, before or after at least one pass of the Dirichlet convolution that produces a plurality of intermediate arrays, performing at least one invertible operation on the plurality of intermediate arrays.

4. The method of claim 3, wherein the at least one invertible operation includes a cyclic shift.

5. The method of claim 3, wherein the at least one invertible operation includes an order reversal.

6. The method of claim 3, wherein the at least one invertible operation includes framing.

7. The method of claim 1, wherein the encryption key is obtained by:
determining at least one dimension of the file;
determining an encryption strength;
generating the encryption key using a random number generator, wherein the encryption key comprises a string of random integers, wherein the number and range of random integers in each encryption key is determined based on the at least one dimension of the file and the encryption strength.

8. The method of claim 7, wherein the file is an image file and the at least one dimension of the file comprises a length dimension and a width dimension.

9. The method of claim 1, wherein the Dirichlet convolution is performed using operations in a finite field.

10. The method of claim 1, wherein the Dirichlet convolution is performed using integer arithmetic with a bit size B.

11. The method of claim 10, wherein the integer arithmetic is performed modulo-P, where P is a prime number larger than the bit size B.

12. The method of claim 11, wherein P the prime number is a smallest prime number larger than the bit size B.

13. The method of claim 1, further comprising providing the encryption key to a recipient of the encrypted file, wherein the encryption key is provided out-of-band to the encrypted file.

14. The method of claim 1, further comprising computing a decryption key, and providing the decryption key to a recipient of the encrypted file, wherein the decryption key is provided out-of-band to the encrypted file.

15. The method of claim 14, wherein the decryption key is the Dirichlet inverse of the encryption key.

16. The method of claim 1 wherein the file is a color image, and wherein the color image is parsed into a plurality of channels, and wherein the encrypting comprises encrypting each of the channels.

17. A method of decrypting an encrypted file, the method comprising:
obtaining a decryption key, the decryption key comprising an integer array;
dividing the encrypted file into a plurality of encrypted arrays of a unit size;
decrypting the plurality of encrypted arrays to generate a plurality of arrays by performing Dirichlet convolution of the decryption key over each of the plurality of encrypted arrays; and
combining the plurality of arrays into a file; and
storing or transmitting the file.

18. The method of claim 17, wherein the decryption key comprises an indication of a number of Dirichlet convolution passes to be performed during the decrypting.

19. The method of claim 17, wherein the decryption key comprises an indication of at least one invertible operation to be performed during the decrypting.

20. A non-transitory computer readable medium storing instructions which, when executed by a computer processor, cause the computer processor to perform the method comprising:
obtaining an encryption key, the encryption key comprising an integer array;
segmenting the file into a plurality of arrays of a unit size;
encrypting the plurality of arrays to generate a plurality of encrypted arrays by performing Dirichlet convolution of the encryption key over each of the plurality of arrays; and
combining the plurality of encrypted arrays into an encrypted file; and
storing or transmitting the encrypted file.
